(19) United States
(12) Patent Application Publication
(10) Pub. No.: US 2007/0025310 A1
(43) Pub. Date: Feb. 1, 2007

(54) Access point and method for selecting a wireless channel

(75) Inventors: Chih-Hung Weng, Tu-Cheng (TW); Wei-Yu Chen, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/344,462

(22) Filed: Jan. 30, 2006

(30) Foreign Application Priority Data
Jul. 27, 2005 (CN) 200510036247.X

(51) Int. Cl. H04Q 7/24

(52) U.S. Cl. 370/338; 370/401

(57) ABSTRACT

An access point (100) for selecting a wireless channel from a plurality of wireless channels to establish a wireless link includes a wireless channel scanning module (110), a wireless channel selecting module (150) and a wireless channel appointing module (170). The wireless channel scanning module is used for obtaining working statuses of the wireless channels. The wireless channel selecting module is used for assigning weighted scores to the wireless channels based on the working statuses thereof, and for selecting an applicable wireless channel based on the weighted scores of the wireless channels. The wireless channel appointing module is used for appointing the applicable wireless channel to the access point. A wireless channel selection method thereof is also provided to avoid interference between different wireless channels of different access points.

### BACKGROUND

1. Field of the Invention

The present invention relates to wireless communications, and particularly to an access point and a wireless channel selection method used for an access point.

2. Related Art

In conventional wireless communication systems applied in a wireless local area network (WLAN), a wireless channel is used by an access point connected to a wired network and one or more mobile stations wirelessly connected to the access point for configuring wireless links among the access point and the mobile stations. This is described in detail in “Wireless LAN Medium Access Control and Physical Layer Specification”, Draft Standard of IEEE 802.11, P802.11D2.0, (July, 1995). A wireless channel is individually appointed to each access point based on propagation characteristics predictions and traffic predictions of the access point. A wireless channel used by each mobile station is selected from the wireless channels appointed to access points of a zone within which the mobile station actually exists, according to a control signal periodically or continuously output from the access points.

However, when wireless channels are individually appointed to each access point according to the propagation characteristics predictions and the traffic predictions of the access point, one wireless channel may be appointed to different access points if the actual propagation characteristics or actual communication traffic of one access point is different from the propagation characteristics prediction or the traffic prediction of the access point. In this situation, interference between the different access points of the same wireless channel can arise.

### SUMMARY

An exemplary embodiment of the present invention provides an access point for selecting a wireless channel from a plurality of wireless channels to establish a wireless link. The access point includes a wireless channel scanning module, a wireless channel selecting module, and a wireless channel appointing module. The wireless channel scanning module is used for obtaining working statuses of the wireless channels. The wireless channel selecting module is used for assigning weighted scores to the wireless channels based on the working statuses thereof, and for selecting an applicable wireless channel based on the weighted scores of the wireless channels. The wireless channel appointing module is used for appointing the applicable wireless channel to the access point.

Another exemplary embodiment of the present invention provides a wireless channel selection method used for an access point. The wireless channel selection method includes the steps of: scanning a plurality of wireless channels to obtain working statuses thereof; assigning weighted scores to the wireless channels based on the working statuses thereof; selecting an applicable wireless channel based on the weighted scores of the wireless channels; and appointing the applicable wireless channel to the access point. The wireless channel selection method avoids interference between wireless channels of different access points.

Other novel features and advantages will become more apparent from the following detailed description when taken in conjunction with the accompanying drawings, in which:

### BRIEF DESCRIPTION OF THE DRAWINGS

FIG. 1 is a schematic diagram illustrating an application environment and functional modules of an access point according to an exemplary embodiment of the present invention;

FIG. 2 is a flowchart of a wireless channel selection method according to an exemplary embodiment of the present invention;

FIG. 3 is a flowchart of a wireless channel selection method according to another exemplary embodiment of the present invention; and

FIG. 4 is a diagram illustrating a weighted scoring table for wireless channels according to an exemplary embodiment of the present invention.

### DETAILED DESCRIPTION OF THE EMBODIMENTS

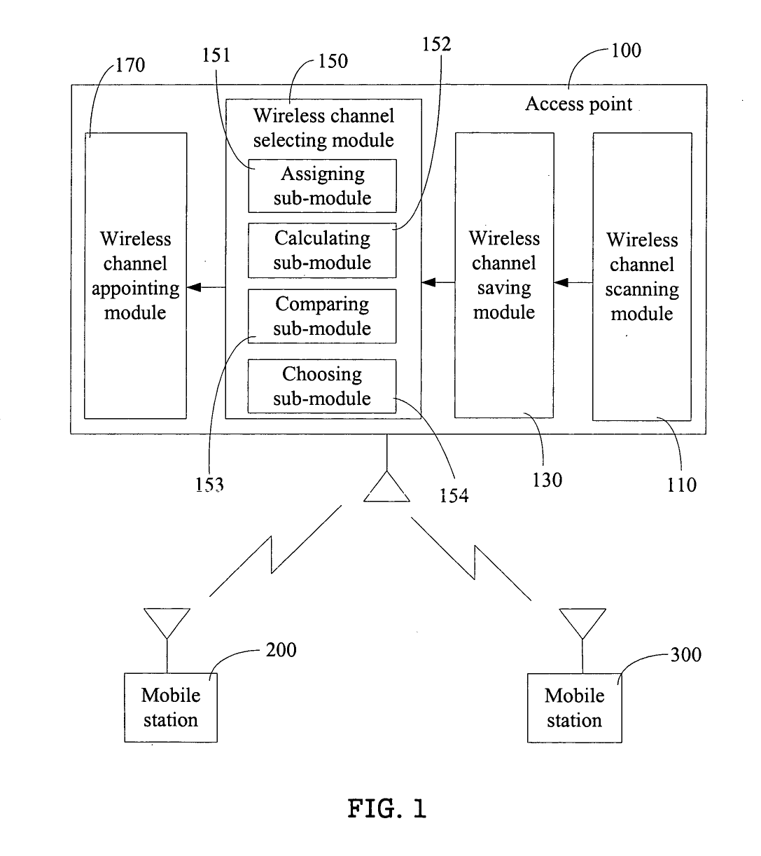

FIG. 1 is a schematic diagram illustrating an application environment and functional modules of a wireless communication device like an access point 100 according to an exemplary embodiment of the present invention. In the exemplary embodiment, the access point 100 is employed by a wireless communication system including a plurality of mobile stations 200, 300. The access point 100 communicates with each of the mobile stations 200, 300 through wireless channels. As shown in FIG. 1, the access point 100 includes a wireless channel scanning module 110, a wireless channel saving module 130, a wireless channel selecting module 150, and a wireless channel appointing module 170.

The wireless channel scanning module 110 is used for obtaining current working statuses of the wireless channels by scanning them. The wireless channel saving module 130 is used for saving the working statuses. The wireless channel selecting module 150 is used for assigning weighted scores to the wireless channels based on the working statuses thereof, and for selecting an applicable wireless channel based on the weighted scores of the wireless channels.

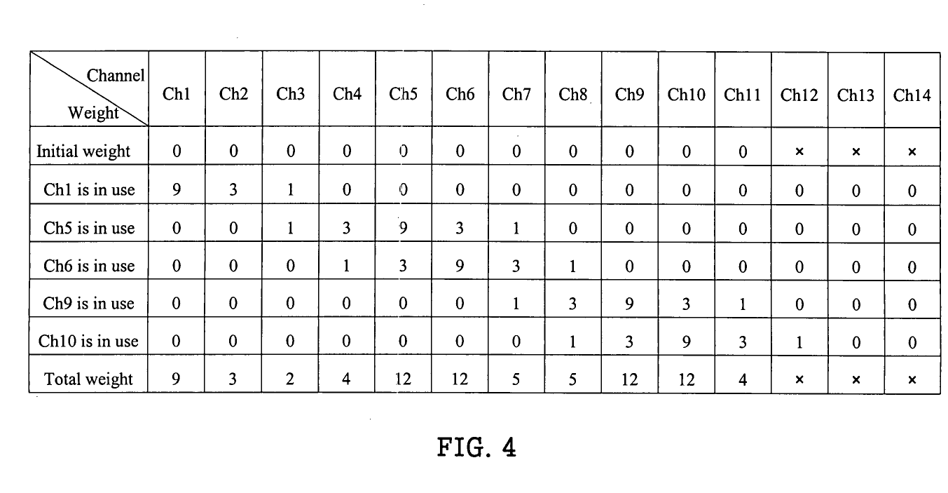

In the exemplary embodiment, the wireless channel selecting module 150 includes an assigning sub-module 151, a calculating sub-module 152, a comparing sub-module 153, and a choosing sub-module 154. The assigning sub-module 151 is used for determining whether the wireless channels are in use based on the working statuses, and for assigning weighted scores to the wireless channels in use and neighboring wireless channels, which is illustrated in FIG. 4. The calculating sub-module 152 is provided for calculating a total score of each wireless channel based on the weighted scores assigned by the assigning sub-module 151. The comparing sub-module 153 is used for comparing the total scores of all wireless channels. The choosing sub-module 154 is used for choosing a wireless channel that is least used according to the result of the comparison. The wireless channel appointing module 170 is used for appointing the chosen wireless channel to the access point 100.

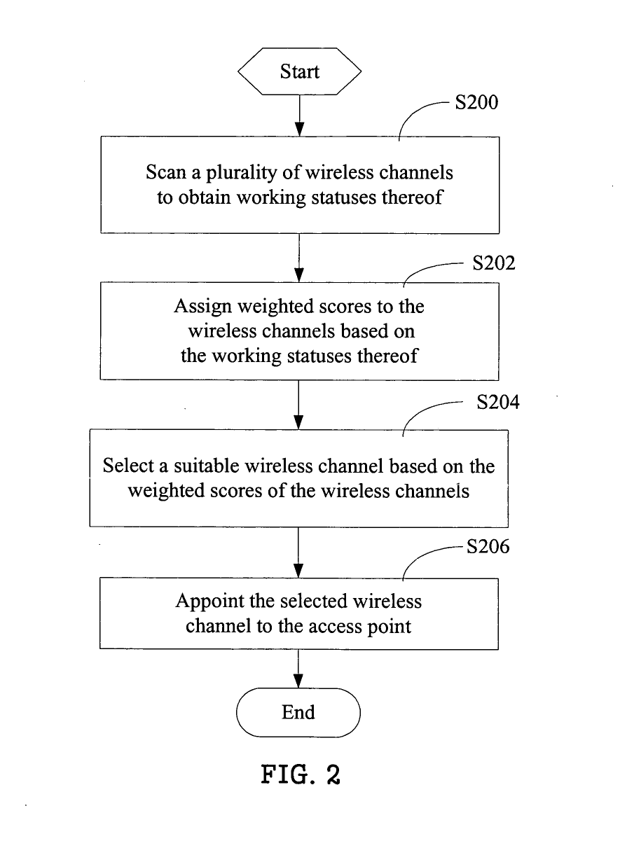

FIG. 2 is a flowchart of a wireless channel selection method according to an exemplary embodiment of the present invention. When establishing a new wireless link, the access point 100 selects a wireless channel for the wireless link.

At step S200, the wireless channel scanning module 110 scans a plurality of wireless channels to obtain working statuses thereof. At step S202, the wireless channel selecting module 150 assigns weighted scores to the wireless channels based on the working statuses thereof. At step S204, the wireless channel selecting module 150 selects an applicable wireless channel based on the weighted scores of the wireless channels. At step S206, the wireless channel appointing module 170 appoints the applicable wireless channel to the access point 100.

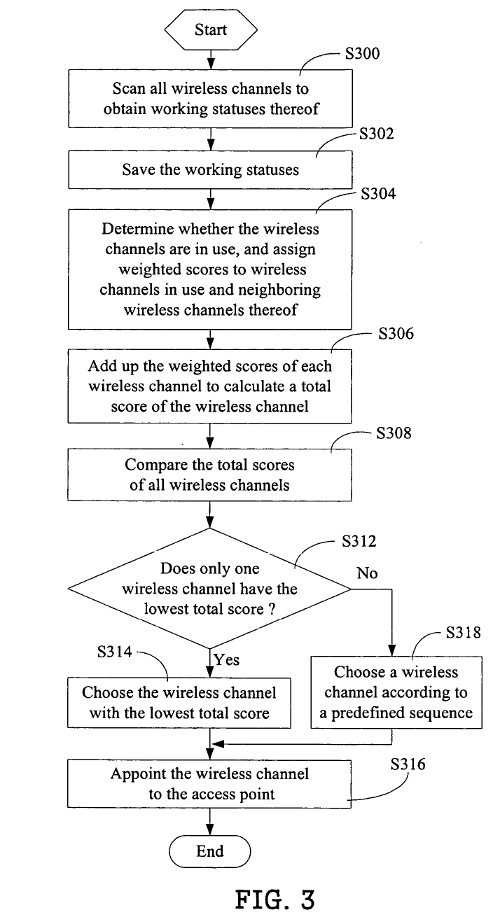

FIG. 3 is a flow chart of a wireless channel selection method according to another exemplary embodiment of the present invention. At step S300, the wireless channel scanning module 110 scans all wireless channels to obtain working statuses thereof. In other embodiments, the wireless channel scanning module 110 may only scan part of the wireless channels to obtain the working statuses thereof. In the exemplary embodiment, when establishing a new wireless link, the access point 100 transmits a request for information complying with the IEEE 802.11 standard to a neighboring access point through a wireless channel. If the wireless channel is in use, the neighboring access point transmits a response to the request for information. If the wireless channel is idle, the neighboring access point does not transmit any response to the request for information. That is, if the access point 100 receives the response to the request for information from the neighboring access point, the access point 100 determines the wireless channel is in use. If the access point 100 does not receive any response to the request for information from the neighboring access point, the access point 100 determines the wireless channel is idle. In this way, the access point 100 can obtain the working statuses on the wireless channels. At step S302, the wireless channel saving module 130 saves the working statuses.

At step S304, the assigning sub-module 151 of the wireless channel selecting module 150 determines whether the wireless channels are in use based on the working statuses, and assigns weighted scores to wireless channels in use and neighboring wireless channels thereof, which is illustrated in FIG. 4. In the exemplary embodiment, each wireless channel in use interferes with the neighboring wireless channels, and the strength of the interference decreases the farther apart from each other the wireless channels are in the electromagnetic spectrum (i.e. channel 5 is farther from channel 1 than channel 2 and so will cause less interference). Therefore, the assigning sub-module 151 assigns a higher weighted score to a wireless channel in use than neighboring wireless channels thereof. In another exemplary embodiment, the assigning sub-module 151 may assign a lower weighted score to the wireless channel in use than the neighboring wireless channels thereof. For example, FIG. 4 illustrates a weighted scoring table for wireless channels according to an exemplary embodiment of the present invention, wherein initial scores of channels 1 to 14 are 0. In the exemplary embodiment, when a wireless channel is in use, for example, channel 1, a score of 9 is assigned, a score of 3 is assigned a neighboring channel 2, and a score of 1 is assigned next neighboring channel 3. In other exemplary embodiments, the channel in use, the neighboring channel and the next neighboring channel can be assigned according to practical need and design. Wireless channels 4 to 14 are treated as having no influence, and their scores are unchanged at 0. When channels 5, 6, and 10 are in use, scores of the channels in use and neighboring channels thereof are accordingly assigned weighted scores.

At step S306, the calculating sub-module 152 adds up the weighted scores of each wireless channel to calculate a total score of the wireless channel as illustrated in the last column of the table of FIG. 4.

At step S308, the comparing sub-module 153 of the wireless channel selecting module 150 compares the total scores of all wireless channels. At step S312, the choosing sub-module 154 determines whether only one wireless channel has the lowest total score. If so, at step S314, the choosing sub-module 154 chooses the wireless channel with the lowest total score. As shown in FIG. 4, in the exemplary embodiment, channel 3 has the lowest total score, so the choosing sub-module 154 chooses channel 3. If more than one wireless channel has the lowest total score, at step S318, the choosing sub-module 154 will choose a wireless channel that has the lowest total score according to a predefined sequence. In another exemplary embodiment, if the assigning sub-module 151 assigns a lower weighted score to the wireless channel in use than neighboring wireless channels thereof, the choosing sub-module 154 chooses a wireless channel with the highest total score. The access point 100 or the mobile stations 200, 300 may not support some wireless channels, for example, channels 12, 13, and 14 in the exemplary embodiment, so the choosing sub-module 154 does not select these wireless channels in spite of their having the lowest scores.

At step S316, the wireless channel appointing module 170 appoints the wireless channel selected by the wireless channel selecting module 150 to the access point 100. In the above example, the wireless channel appointing module 170 appoints channel 3 to the access point 100.

While embodiments and applications of this invention have been shown and described, it should be apparent to those skilled in the art having the benefit of this disclosure that many more modifications other than those mentioned above are possible without departing from the inventive concepts herein. The invention, therefore, is not to be restricted other than by the scope and spirit of the appended claims.

1. An access point for selecting a wireless channel from a plurality of wireless channels to establish a wireless link, the access point comprising:
a wireless channel scanning module for obtaining working statuses of the wireless channels;
a wireless channel selecting module for assigning weighted scores to the wireless channels based on the working statuses thereof, and selecting an applicable wireless channel based on the weighted scores of the wireless channels; and
a wireless channel appointing module for appointing the applicable wireless channel to the access point.

2. The access point as claimed in claim 1, further comprising a wireless saving module for saving the working statuses.

3. The access point as claimed in claim 1, wherein the wireless channel selecting module comprises an assigning sub-module for determining whether the wireless channels are in use based on their working statuses, and assigning weighted scores to the wireless channels.

4. The access point as claimed in claim 3, wherein the wireless channel selecting module further comprises a calculating sub-module for calculating a total score of each wireless channel based on the weighted scores assigned by the assigning sub-module.

5. The access point as claimed in claim 4, wherein the wireless channel selecting module further comprises a comparing sub-module for comparing the total scores of all wireless channels.

6. The access point as claimed in claim 5, wherein the wireless channel selecting module further comprises a choosing sub-module for choosing the applicable wireless channel that is least used according to the total scores.

7. A wireless channel selection method used for an access point, comprising the steps of:
scanning a plurality of wireless channels to obtain working statuses thereof;
assigning weighted scores to the wireless channels based on the working statuses thereof;
selecting an applicable wireless channel based on the weighted score of the wireless channels; and
appointing the applicable wireless channel to the access point.

8. The wireless channel selection method as claimed in claim 7, wherein the scanning step comprises the steps of:
transmitting a request for information to a neighboring access point through a wireless channel; and
determining a working status of the wireless channel; wherein if a response to the request for information is received from the neighboring access point, the wireless channel is in use.

9. The wireless channel selection method as claimed in claim 8, wherein in the determining step, if a response to the request for information is not received from the neighboring access point, the wireless channel is idle.

10. The wireless channel selection method as claimed in claim 7, wherein the assigning step comprises the steps of:
determining whether the wireless channels are in use based on the working statuses, and assigning weighted scores to the wireless channels; and
adding up the weighted scores of each wireless channel to calculate a total score of the wireless channel.

11. The wireless channel selection method as claimed in claim 10, wherein the selecting step comprises the steps of comparing the total scores of each of the wireless channels, and accordingly selecting the applicable wireless channel.

12. The wireless channel selection method as claimed in claim 11, wherein a wireless channel that is in use is assigned a higher score than neighboring wireless channels thereof.

13. The wireless channel selection method as claimed in claim 12, wherein the selected wireless channel has the lowest total score.

14. The wireless channel selection method as claimed in claim 13, wherein if more than one wireless channel has the lowest score, the wireless channel is selected according to a predefined sequence.

15. The wireless channel selection method as claimed in claim 11, wherein a wireless channel that is in use is assigned a lower score than neighboring wireless channels thereof.

16. The wireless channel selection method as claimed in claim 15, wherein the selected wireless channel has the highest total score.

17. The wireless channel selection method as claimed in claim 16, wherein if more than one wireless channel has the highest total score, the wireless channel is selected according to a predefined sequence.

18. The wireless channel selection method as claimed in claim 7, further comprising the step of saving the working statuses.

19. A method to select a workable wireless channel for a wireless communication device, comprising the steps of:
identifying a plurality of availably workable wireless channels in a reachable range of a wireless communication device;
scanning said plurality of wireless channels to obtain corresponding working statuses thereof;
weighing each of said plurality of wireless channels based on said corresponding working statuses thereof; and
assigning a selective one of said plurality of wireless channels to said wireless communication device for use due to a favorably weighed result of said selective one of said plurality of wireless channels.

20. The method as claimed in claim 19, wherein, in said weighing step, a wireless channel and neighboring wire channels thereof out of said plurality of wireless channels are targeted to weigh when said wireless channel is identifiably used by another wireless communication device according to said corresponding working statuses thereof.
